(19) United States
(12) Patent Application Publication
(10) Pub. No.: US 2013/0093177 A1
(43) Pub. Date: Apr. 18, 2013

(54) Credit Card Self-Adhesive Pull Tab and Method of Using the Same

(71) Applicant: Harrington Nena, Fabius, NY (US)

(72) Inventor: Harrington Nena, Fabius, NY (US)

(21) Appl. No.: 13/650,866

(22) Filed: Oct. 12, 2012

Related U.S. Application Data
(60) Provisional application No. 61/546,282, filed on Oct. 12, 2011.

(51) Int. Cl. B42D 15/00

(52) U.S. Cl. 283/81

(57) ABSTRACT

The present invention relates to a device and a method for quickly and easily locating and obtaining at least one credit card, ID card, drivers license, business card and the like from a confined space and, more particularly, to a uniquely identifiable self-adhesive pull tab that can be attached to the such a card for a quick and easy retrieval of the same from the confined space.

### CROSS REFERENCE To RELATED APPLICATION

The present application claims priority to U.S. Provisional Patent Application, Ser. No. 61/546,282, filed Oct. 12, 2011, the entirety of which is hereby incorporated by reference

### BACKGROUND OF THE INVENTION

1. Field of the Invention

The present invention relates to a device and a method for quickly and easily locating and obtaining at least one credit card, ID card, drivers license, business card and the like from a confined space and, more particularly, to a uniquely identifiable self-adhesive pull tab that can be attached to the such a card for a quick and easy retrieval of the same from the confined space.

2. Description of the Related Art

The typical wallet and/or money clip and the like (collectively “card holder”) needs to hold a variety of credit cards, business cards, ID cards, drivers licenses, etc. (collectively “cards”) in a confined space. Additionally, the cards are more often than not covered by the card holder or other cards within the card holder. This scenario results in the difficulty of quickly locating and obtaining a card(s) that may be required in a given situation, and the need for the user to sift through a number of cards until the required card(s) is located and obtained.

### SUMMARY OF THE INVENTION

It is a principal object and advantage of an embodiment of the present invention to provide a device and a method for quickly and easily locating and obtaining at least one card from a confined space.

In accordance with the foregoing object and advantage of the present invention, an embodiment of the present invention provides a uniquely identifiable self-adhesive pull tab that can be attached to the card. The uniquely identifiable self-adhesive pull tab includes, but is not limited to, a plastic tab comprising a plurality of sections, and a fold line. In a preferred embodiment, the plastic tab contains approximately four equally sized sections, two on either side of the fold line. The sections immediately adjacent to the fold line do not contain any adhesive coating. However, each of the remaining sections contains an adhesive coating on one side, respectively, which will meet when the self-adhesive pull tab is folded upon use. The self-adhesive pull tabs of the present invention can be made of different colors, have numbers or letters on outside of the non-adhesively coated sections when folded, or contain other uniquely identifiable characters.

In accordance with an additional embodiment of the present invention, a method of using the uniquely identifiable self-adhesive pull tab is provided as described in the Detailed Description section below.

### BRIEF DESCRIPTION OF THE DRAWINGS

The present invention will be more fully understood and appreciated by reading the following Detailed Description in conjunction with the accompanying drawing(s), in which:

FIGS. 1a-d show various views of the uniquely identifiable self-adhesive pull tab in folded and unfolded configurations, and in use on a credit card, in accordance with an embodiment of the present invention.

### DETAILED DESCRIPTION

The present invention will be more fully understood and appreciated by reading the following Detailed Description in conjunction with the accompanying drawing(s), wherein like reference numerals refer to like components.

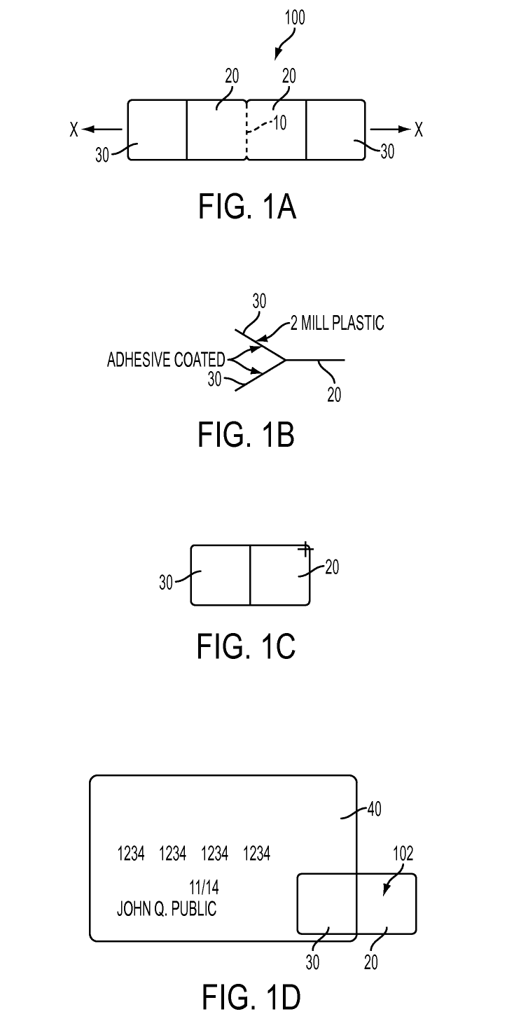

Turning to FIGS. 1a-d, various views of the uniquely identifiable self-adhesive pull tab 100 in folded and unfolded configurations, and in use on a credit card 40, are shown in accordance with an embodiment of the present invention.

FIG. 1a shows the uniquely identifiable self-adhesive pull tab 100 in an unfolded condition extending along a longitudinal axis X-X. A fold line 10 is positioned at the transverse midpoint, two immediately adjacent sections 20 to the fold line (each of which preferably do not contain any adhesive coating) extend longitudinally outward, and two additional sections 30 (each of which contains an adhesive coating on at least a portion of one side, respectively, extend from the respective terminal ends of sections 20 and are adapted to meet when the self-adhesive pull tab 100 is folded upon use) are shown.

FIG. 1b is a side view of the uniquely identifiable self-adhesive pull tab 100 in a folded condition. The self-adhesive pull tab 100 has been folded at the fold line 10 toward the adhesive sides of sections 30, and the adhesive sides of sections 30 are shown in an open, non-contacting position. The adhesive sides of sections 30 may be directly adhesive (i.e., no non-adhesive covering), or there could be a non-adhesive film layer that could be removed to reveal the adhesive layer prior to use. FIG. 1c is a top view of FIG. 1b.

FIG. 1d shows the uniquely identifiable self-adhesive pull tab 100 in use on a credit card 40. The adhesive sections 30 have been applied/fastened to the non-operable portion of a credit card 40, while sections 20 are folded together and extend beyond credit card 40. The credit card 40 can then be placed in a wallet, money clip, or other confined space with the uniquely identifiable self-adhesive pull tab 100. The uniquely identifiable self-adhesive pull tab 100 can then be used to quickly and easily locate and obtain the credit card 40 so uniquely identified with indicia 102 when needed by pulling on the particular self-adhesive pull tab 100. Other self-adhesive pull tabs 100 may be used to uniquely identify other cards that are in the same confined space as credit card 40, for non-limiting example, use of distinctive colors (e.g., blue for ATM cards, red for credit cards, yellow for driver's license, etc.), numbers (e.g., 1 for ATM cards, 2 for credit cards, 3 for driver's license, etc.), letters (e.g., A for ATM cards, C for credit cards, D for driver's license, etc.), or shapes ((e.g., circle for ATM cards, square for credit cards, triangle for driver's license, etc.).

While several embodiments of the invention have been discussed, it will be appreciated by those skilled in the art that various modifications and variations of the present invention are possible. Such modifications do not depart from the spirit and scope of the present invention.

What is claimed is:

1) A tab to be applied to a card, comprising:
a) an elongated strip of material that extends along a longitudinal axis;
b) wherein said strip comprises:
i) a fold line extending transverse to the longitudinal axis at about the midpoint of said strip;
ii) first and second pull sections extending longitudinally outward in opposing directions from said fold line; and
iii) first and second adhesive sections extending longitudinally outward from sad first and second pull sections, respectively, wherein each of said fist and second adhesive sections comprises an adhesive coating covering at least a portion of one side of each of said first and second adhesive sections, whereby said first and second adhesive sections are adapted to be secured in adhered condition to opposing sides of the card.

2) The tab according to claim 1, further comprising first and second pieces of release paper positioned in covering relation to said adhesively coated surface of said first and second adhesive sections, respectively.

3) The tab according to claim 1, wherein at least one of said first and second pull sections contains card identifying indicia.

4) The tab according to claim 3, wherein said indicia comprise a distinctive color.

5) The tab according to claim 3, wherein said indicia comprise a distinctive number.

6) The tab according to claim 3, wherein said indicia comprise a distinctive letter.

7) The tab according to claim 3, wherein said indicia comprise a distinctive shape.
